(19) United States
(12) Patent Application Publication
(10) Pub. No.: US 2010/0329680 A1
(43) Pub. Date: Dec. 30, 2010

(54) OPTICAL NETWORKS

(76) Inventors: Marco Presi, Pisa (IT); Giampiero Contestabile, Pisa (IT); Ernesto Ciaramella, Roma (IT); Fabio Cavaliere, Vecchiano (IT); Roberto Proiettii, Pisa (IT); Antonio D'Errico, Pisa (IT); Pierpaolo Ghiggino, Pisa (IT)

Correspondence Address: NIXON & VANDERHYE, PC, 901 NORTH GLEBE ROAD, 11TH FLOOR, ARLINGTON, VA, 22203, US

(21) Appl. No.: 12/740,464

(22) PCT Filed: Apr. 1, 2008
(86) PCT No.: PCT/EP08/53882

§ 371 Date: Sep. 7, 2010

(30) Foreign Application Priority Data
Oct. 29, 2007 (EP) 07119519.2
Feb. 7, 2008 (EP) 08151150.3

(51) Int. Cl. H04J 14/02

(52) U.S. Cl. 398/79

(57) ABSTRACT

The invention relates to improvements in or relating to optical networks. Methods and apparatus are disclosed for providing communications services to at least one user. Transmission of an optical signal in the downstream direction is described comprising at least one Wavelength Division Multiplexing channel such that at least one of the channels is an unmodulated channel. The unmodulated channel is arranged to transmit user data from the at least one user in the upstream direction.

### TECHNICAL FIELD

The invention relates to improvements in or relating to Optical Networks, and in particular, although not exclusively to Passive Optical Networks.

### BACKGROUND

Broadband access networks of the prior art are mainly based on Passive Optical Networks (PONs). Such PONs allow a single optical fibre to serve multiple end users and are considered to be passive because they utilise unpowered optical splitters to broadcast signals in the downstream direction. Known PONs consist of an Optical Line Terminal (OLT) at a Central Office (CO) of a service provider, and a plurality of Optical Network Units (ONUs), or Optical Network Terminations (ONTs), which include optical splitters and which are near to end users.

In such a PON it is known to transmit a carrier wavelength of 1490 nm in the downstream direction from the CO to end users, and a different wavelength of 1310 nm is transmitted in the upstream direction from the end users to the CO. Both frequencies are modulated at 1.244 Gb/s. The two wavelengths are different to minimise interference so that it is possible to use the same fibre in the downstream and upstream directions. Such a PON reduces the requirement for CO equipment and the amount of optical fibre when compared to point-to-point network architectures.

In such a network the laser for communication of traffic in the upstream direction is required to be placed in a remote cabinet close to the user. Such a remote cabinet imposes strict requirements in terms of cost, power consumption and reliability. These requirements could not be met by lasers typically available, especially when Wavelength Division Multiplexing (WDM) transmission is used to increase the system capacity. Such a laser would be required to have a stable frequency output to avoid interference with adjacent WDM channels. The laser would also be required to be tuneable to provide colourless operation and to minimize the inventory of the remote cabinet and simplify the network management. Such requirements would further increase the cost which means that using a laser to generate the upstream carrier frequencies independently of the downstream carrier frequencies is prohibitively expensive.

It is also known to provide a Wavelength Division Multiplexing PON (WDM-PON) which uses multiple optical wavelengths to increase the upstream and/or downstream bandwidth available for end users. The multiple wavelengths of a WDM-PON can be used by different Optical Network Units (ONUs) to create several virtual PONs which co-exist on the same physical infrastructure.

Typically within prior art systems the upstream and downstream communication between the CO and the ONUs is performed over the same optical fibre. The main driver for using a single fibre is the desire to maintain a low overall cost for access networks by minimising the amount of optic fibre. The prior art points in the direction of using a single fibre which is said to preserve compatibility with existing user interfaces.

A problem associated with using the same optical fibre for a bidirectional link is that there are propagation penalties. Bidirectional communication over the same optical fibre may cause cross-talk between the upstream and downstream channels due to Raylegh backscattering and reflections at splices or connectors. Furthermore such bidirectional communication typically requires additional optical devices, for example circulators and WDM splitters, which are another cause of cross talk due to their finite optical isolation. Such interference degrades the receiver performance and ultimately the available bandwidth.

A further problem associated with bidirectional communication over the same optical fibre is that additional equipment is required at the OLT to separate the downstream and the upstream channels. Such additional equipment may include Erbium Doped Optical Amplifiers (EDFAs) used as bidirectional amplifiers to improve the optical signal quality and to increase the distance over which optical signals can travel. Such bidirectional amplifiers do not perform as well as unidirectional optical amplifiers typically available, and are typically very complex and expensive.

### SUMMARY

An object of the invention is to provide a way of improving optical communication networks whilst reducing the above-mentioned problems.

According to a first aspect of the invention, there is provided a communications node for providing communications services to at least one user. The node being arranged to transmit an optical signal comprising at least one Wavelength Division Multiplexing channel in a downstream direction. Wherein at least one of the channels is an unmodulated channel which is further arranged to transmit user data from the at least one user in the upstream direction.

Such a node using unmodulated channels transmitted in a downstream direction to transmit user data in the upstream direction avoids the need for optical components at the user location such as an expensive tuneable and frequency-stable laser. Such optical devices are expensive, add complexity and generally add to the component count of the network which increases the likelihood that breakdowns will occur. Eliminating the need for such a laser and other optical components at the user location reduces costs and complexity in the network equipment.

The optical signal may be comprised of at least one modulated Wavelength Division Multiplexing channel, and preferably the optical signal may be comprised of alternate wavelengths of modulated and unmodulated Wavelength Division Multiplexing channels. This means that the modulated and unmodulated channels are next to each other in wavelength. Alternatively the optical signal may be comprised of groups of adjacent wavelengths of modulated and unmodulated WDM channels, for example one, two or more modulated channels next to one, two or more unmodulated WDM channels in wavelength.

Preferably the communications node is further arranged to transmit the optical signal in the downstream direction to a Wavelength Division Multiplexing splitter, the splitter arranged to demultiplex the channels and to separate the modulated channels from the unmodulated channels, the splitter further arranged to receive the user data for transmission in the upstream direction.

Preferably the splitter includes a Wavelength Division Multiplexing deinterleaver to separate the modulated channels from the unmodulated channels.

Preferably the splitter is arranged to associate a separated modulated channel with a separated unmodulated channel, and to transmit the associated modulated and unmodulated channels in the downstream direction.

The splitter may associate the modulated and unmodulated channels using a coupler, for example a 2:1 coupler. It will be appreciated that any N:1 coupler could be used such as 3:1, 4:1, 5:1 etc.

Preferably the communications node is further arranged to transmit the associated modulated and unmodulated channel to a user device, the user device being arranged to:
transmit the modulated channel to the at least one user;
receive the user data; and
modulate the unmodulated channel using the user data for transmission of the user data in the upstream direction.

Preferably the user device further includes a user deinterleaver to separate the modulated channel from the unmodulated channel.

The user device may further include an optical circulator to distinguish the modulated channel from the user data. The user device may further include an optical splitter to separate or receive data streams of the respective at least one user.

Preferably the user device is further arranged to transmit the user data from the optical circulator to an optical-to-electrical converter to convert the user data into an upstream electrical signal.

Preferably the user device is further arranged to use the upstream electrical signal to modulate the unmodulated channel from the user deinterleaver.

In an alternative embodiment the user device may include an optical-to-electrical converter to convert the modulated channel into a downstream electric signal. The user device may further include an electrical splitter to separate data streams for the respective at least one user.

In this embodiment the user device may further include means for transmitting the downstream electric signal to the at least one user as a downstream radio frequency signal. The user device may further include means for receiving user data from the at least one user as an upstream radio frequency signal.

Preferably the user device further includes an electrical coupler to combine the user data into an upstream electrical signal.

In an alternative embodiment the user device further includes an optical-to-electrical converter to convert the modulated channel into a downstream electrical signal.

Preferably the user device includes a Forward Error Correction Decoder to process the downstream electrical signal.

Preferably the user device further includes a Time Division Multiplexing demultiplexer to process the downstream electrical signal to separate data streams for the respective at least one user.

Preferably the user device further includes a Time Division Multiplexing multiplexer to combine user data into an upstream electric signal.

Preferably the communications node further includes an optical periodic notch filter which is operable to separate the at least one unmodulated Wavelength Division Multiplexing channel from the modulated Wavelength Division Multiplexing channel.

Preferably outputs of the node are arranged so that pairs of optical fibres carry a modulated Wavelength Division Multiplexing channel and an unmodulated Wavelength Division Multiplexing channel respectively.

The node may be arranged to receive the optical signal from the upstream direction over a single optical fibre. The node may be arranged to transmit the optical signal in the upstream direction over a single optical fibre. Using a single optical fibre is advantageous because the upstream and downstream signals share the same fibre and thereby maximize the system efficiency whilst keeping costs to a minimum.

Preferably the node is arranged to receive user optical data from an upstream direction at a radio frequency.

Preferably the node is arranged to transmit the user data in a downstream direction on one optical fibre, and the at least one unmodulated channel on another optical fibre.

Preferably the at least one modulated channel is comprised of at least one optical single side band modulated signal. This provides the advantage of allowing easier separation of the data signal from its carrier frequency.

According to a second aspect of the invention there is provided a communications node for providing communications services to at least one user. The node being arranged to receive an optical signal comprising at least one Wavelength Division Multiplexing channel from an upstream direction. Each channel comprising a carrier frequency and optical data. The node being arranged to separate the respective carrier frequency from the optical data. The node further arranged to transmit the separated optical data and the carrier frequency in the downstream direction. Wherein the at least one carrier frequency is arranged to transmit user data from the at least one user in the upstream direction.

Preferably the node includes an optical circulator for receiving optical signals from a downstream direction. Preferably the node includes an optical circulator for transmitting optical signals in an upstream direction.

Preferably the node includes an optical periodic notch filter which is operable to separate the at least one carrier frequency from optical data.

Preferably the node has outputs arranged as pairs of optical fibres, one fibre of each pair of optical fibres having a modulated Wavelength Division Multiplexing channel and the other optical fibre of each pair having an unmodulated Wavelength Division Multiplexing channel.

Preferably the user data is transmitted as an optical single side band modulated signal. This provides the advantage of allowing easier separation of the data signal from its carrier frequency.

The node may be arranged to receive the optical signal from the upstream direction over a single optical fibre. The node may be arranged to transmit an optical signal in the upstream direction over a single optical fibre.

According to a third aspect there is provided a communications node for providing communications services to at least one user. The node being arranged to transmit an optical signal comprising at least one Wavelength Division Multiplexing channel in a downstream direction. Wherein each channel comprises a carrier frequency and optical data for the at least one user. The node being further arranged to receive an upstream optical signal comprising the at least one carrier frequency and user data from the at least one user.

Preferably the node includes an optical single side band modulator for generating the downstream optical signal. Preferably the optical single side band modulator is a Mach-Zender modulator. This provides the advantage of allow easier separation of the data signal from its carrier frequency.

Preferably the node further includes a radio frequency convertor to convert the downstream optical data into a radio frequency.

The node may be arranged to transmit the downstream optical signal over a single optical fibre.

Preferably the node includes an optical circulator for receiving optical signals from a downstream direction. Preferably the node includes an optical circulator for transmitting optical signals in a downstream direction.

According to a fourth aspect of the invention there is provided a Wavelength Division Multiplexing splitter arranged to receive an optical signal comprising at least one Wavelength Division Multiplexing channel from an upstream direction. Wherein one or more of the channels are modulated channels. At least one of the channels is an unmodulated channel. The splitter being arranged to demultiplex the channels and to separate the modulated channels from the unmodulated channels to provide communication services to at least one user in a downstream direction. The splitter further arranged to receive user data for transmission in the upstream direction which has been used to modulate the at least one unmodulated channels.

Preferably the splitter includes a Wavelength Division Multiplexing deinterleaver to separate the modulated channels from the unmodulated channels.

Preferably the splitter is further arranged to associate a separated modulated channel with a separated unmodulated channel, and to transmit the associated modulated and unmodulated channels in the downstream direction.

Preferably the splitter is further arranged to associate the modulated and unmodulated channels using a coupler, for example a 2:1 coupler. It will be appreciated that any N:1 coupler could be used such as 3:1, 4:1, 5:1 etc.

Preferably the splitter is further arranged to transmit the optical signal comprising one modulated channel and one unmodulated channel to a user device.

According to a fifth aspect of the invention there is provided a user device arranged to receive an optical signal comprising an unmodulated Wavelength Division Multiplexing channel from an upstream direction. The user device being arranged to receive user data from a downstream direction. The user device being further arranged to modulate the unmodulated channel with the user data for transmission of the user data in the upstream direction.

Preferably the user device is arranged to receive an optical signal from an upstream direction comprising at least one modulated Wavelength Division Multiplexing channels, and to transmit the at least one modulated Wavelength Division Multiplexing channel to at least one user in the downstream direction.

Preferably the user device further includes a user deinterleaver to separate the modulated channel from the unmodulated channel.

Preferably the user device further includes an optical circulator to distinguish the modulated channel from the upstream user data. The user device may further include an optical splitter to separate or receive data streams of the at least one user.

Preferably the user device is further arranged to transmit the user data from the optical circulator to an optical-to-electrical converter to convert the user data into an upstream electrical signal.

Preferably the user device is further arranged to use the upstream electrical signal to modulate the unmodulated channel from the user deinterleaver.

In an alternative embodiment the user device may include an optical-to-electrical converter to convert the modulated channel into a downstream electrical signal. The user device may further include an electrical splitter to separate user data streams for the at least one user.

In this embodiment the user device may further include means for transmitting the downstream electric signal to the at least one user as a downstream radio frequency signal. The user device may further include means for receiving user data from the at least one user as an upstream radio frequency signal.

Preferably the user device further includes an electrical coupler to combine the user data into an upstream electrical signal.

In an alternative embodiment the user device further includes an optical-to-electrical converter to convert the modulated channel into a downstream electrical signal.

Preferably the user device includes a Forward Error Correction Decoder to process the downstream electrical signal.

Preferably the user device further includes a Time Division Multiplexing demultiplexer to process the downstream electric signal to separate data streams for the at least one user.

Preferably the user device further includes a Time Division Multiplexing multiplexer to combine user data into an upstream electric signal.

Preferably the user device further includes a reflective semiconductor optical amplifier arranged to receive the unmodulated Wavelength Division Multiplexing channel, to modulate the unmodulated Wavelength Division Multiplexing channel with the user data and to transmit the modulated channel in the upstream direction.

Preferably the user device is arranged to receive user data from an upstream direction at a radio frequency.

The user device may be arranged to communicate with at least one user via a radio interface.

Preferably the user device is arranged to receive the user data from an upstream direction on one optical fibre, and the unmodulated Wavelength Division Multiplexing channel on another optical fibre.

According to a sixth aspect there is provided a method of operating a communications network for providing communications services to at least one user. The method including transmitting an optical signal comprising at least one at least one Wavelength Division Multiplexing channel in a downstream direction. Wherein at least one of the channels is an unmodulated channel. The method including using the at least one unmodulated channel to transmit user data from the at least one user in the upstream direction.

Such a method has the advantage of reusing the downstream signal to generate the upstream signal. Reusing the downstream signal avoids the requirement for expensive laser equipment at or near to the user location.

Preferably the method further includes transmitting at least one modulated channel in the optical signal.

Preferably the method further includes using an optical signal having alternate wavelengths of modulated and unmodulated Wavelength Division Multiplexing channels. This means that the modulated and unmodulated channels are next to each other in wavelength. Alternatively the optical signal may be comprised of groups of adjacent wavelengths of modulated and unmodulated Wavelength Division Multiplexing channels, for example one, two or more modulated channels next to one, two or more unmodulated Wavelength Division Multiplexing channels in wavelength.

Preferably the method further includes demultiplexing the at least one Wavelength Division Multiplexing channel and separating the modulated channels from the unmodulated channels.

Preferably the method further includes associating a separated modulated channel with a separated unmodulated channel, and transmitting the associated modulated and unmodulated channels in the downstream direction.

Preferably the method further includes transmitting the associated modulated and unmodulated channel to a user device for transmitting the modulated channel to the at least one user, receiving the user data; and modulating the unmodulated channel using the user data for transmission of the user data in the upstream direction.

Preferably the method further includes including distinguishing the modulated channel from the user data.

According to a seventh aspect there is provided a method of operating a communications node for providing communications services to at least one user. The method including transmitting a downstream optical signal from the node comprising at least one Wavelength Division Multiplexing channel. Wherein each channel comprises a carrier frequency and optical data for the at least one user. The method including receiving an upstream optical signal at the node comprising the at least one carrier frequency and user data from the at least one user.

Preferably the method further includes using an optical single side band modulated signal as the downstream optical signal. This provides the advantage of allow easier separation of the data signal from its carrier frequency.

Preferably the method further includes converting the downstream optical data into a radio frequency.

The method may include transmitting the downstream optical signal over a single optical fibre.

Preferably the method further includes receiving optical signals from a downstream direction at an optical circulator of the node. Preferably the method further includes transmitting the optical signal in a downstream direction from an optical circulator of the node.

According to an eighth aspect there is provided a method of operating a communications node for providing communications services to at least one user. The method including receiving an optical signal at the node from an upstream direction. The optical signal comprising at least one Wavelength Division Multiplexing channel comprising a carrier frequency and optical data. The method including separating the respective carrier frequency from the optical data. The method further including transmitting the carrier frequency from the node in the downstream direction. The method including transmitting user data from the at least one user in the upstream direction using the at least one carrier frequency.

Preferably the method further includes transmitting the separated optical data from the node in the downstream direction.

Preferably the method further includes receiving an optical signal at an optical circulator of the node from a downstream direction.

Preferably the method further includes transmitting an optical signal from an optical circulator of the node in an upstream direction.

Preferably the method further includes arranging outputs of the node as pairs of optical fibres, one fibre of each pair of optical fibres having a modulated Wavelength Division Multiplexing channel and the other optical fibre of each pair having an unmodulated Wavelength Division Multiplexing channel.

Preferably the method further includes transmitting the optical data using at least one optical single side band modulated signal. This provides the advantage of allow easier separation of the data signal from its carrier frequency.

The method may include receiving the optical signal from the upstream direction over a single optical fibre. The method may include transmitting the optical signal in the upstream direction over a single optical fibre.

According to a ninth aspect there is provided a method of operating a user device for providing communications services to at least one user. The method including receiving an optical signal from an upstream direction comprising an unmodulated WDM channel. The method including receiving user data at the user device from a downstream direction. The method including modulating the unmodulated WDM channel with the user data. The method including transmitting the user data in the upstream direction.

Preferably the method further includes receiving an optical signal at the user device from an upstream direction comprising at least one modulated Wavelength Division Multiplexing channel, and transmitting the at least one modulated Wavelength Division Multiplexing channel to the at least one user.

Preferably the method further includes receiving the unmodulated Wavelength Division Multiplexing channel at a reflective semiconductor optical amplifier, modulating the unmodulated Wavelength Division Multiplexing channel with the user data, and transmitting the modulated channel in the upstream direction.

Preferably the method further includes receiving the user data from an upstream direction on one optical fibre, and the unmodulated WDM channel on another optical fibre.

Preferably the method further includes receiving user data from an upstream direction at a radio frequency.

The method may include communicating with at least one user via a radio interface.

According to a tenth aspect there is provided a communications network including a communications node according to the first to third aspects, a Wavelength Division Multiplexing splitter according to the fourth aspect, a user device according to the fifth aspect, or arranged to perform a method according to any of the sixth to ninth aspects.

It will be appreciated that any preferred or optional features of one aspect of the invention may be preferred or optional feature of other aspects of the invention.

### BRIEF DESCRIPTION OF THE DRAWINGS

Other features of the invention will be apparent from the following description of preferred embodiments shown by way of example only with reference to the accompanying drawings, in which;

FIG. 1 shows a network according to an embodiment of the invention;

FIG. 2 shows a Wavelength Divisional Multiplexing splitter for use in the network of FIG. 1;

FIG. 3 shows a Multi User Box for use in the network of FIG. 1;

FIG. 4 shows a Multi User Box for use in the network of FIG. 1 according to an alternative embodiment;

FIG. 5 shows a Multi User Box for use in the network of FIG. 1 according to an alternative embodiment;

FIG. 6 shows a network according to an embodiment of the invention;

FIG. 7 shows a central office node for use in the network of FIG. 6;

FIG. 8 shows a Wavelength Division Multiplexing (WDM) node for use in the network of FIG. 6;

FIG. 9 shows graphs illustrating the operation of a periodic notch filter;

FIG. 10 shows an optical network termination according to an embodiment of the invention;

FIG. 11 show a radio interface termination according to an alternative embodiment;

FIG. 12 show a user radio interface for use with the radio interface termination of FIG. 11;

FIG. 13 shows an experimental setup for the architecture of FIGS. 6-8 and 10;

FIG. 14 shows experimental results for upstream and downstream signals in FIG. 13; and

FIG. 15 shows a flow diagram illustrating a method according to an embodiment of the invention.

### DETAILED DESCRIPTION

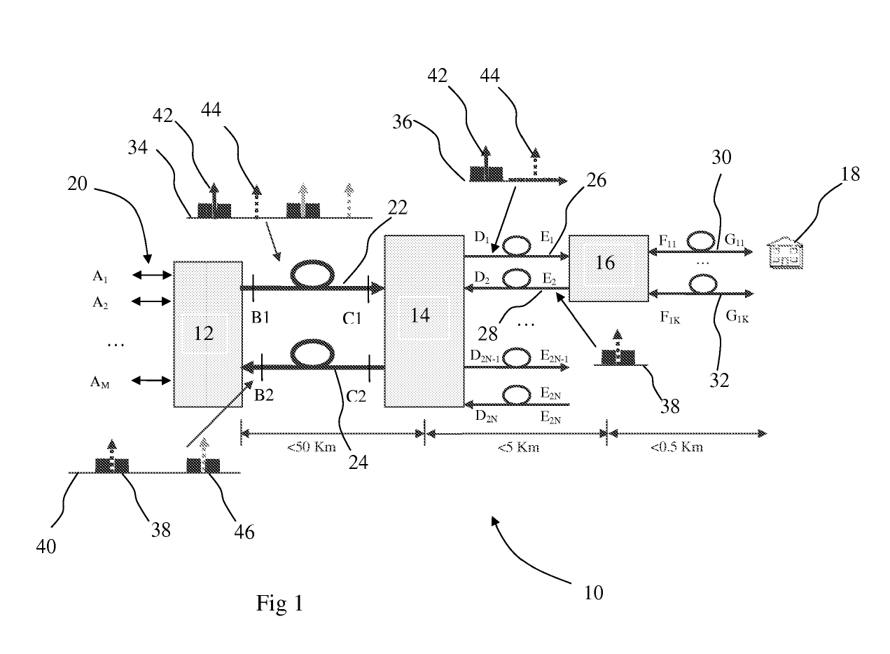

FIG. 1 shows a network according to an embodiment of the invention, generally designated 10. The network 10 has an Optical Line Terminal (OLT) 12, also known as a node, which is an edge device of a larger network which may have many OLTs (not shown). The OLT 12 is in communication with a Wavelength Division Multiplexing Splitter 14 which is in turn in communication with a Multi User Box (MUB) 16, or user device. The MUB 16 is in turn in communication with a user 18. FIG. 1 has been simplified for the purposes of clarity to show one WDM splitter 14, one MUB 16, and one user 18. It will be appreciated that in the real world example, there may be many WDM splitters 14 where each WDM splitter 14 serves N Multi User Boxes 16. In this example N is typically forty. It will also be appreciated that in the real world example each WDM splitter 14 serves K users 18, and in this example K is typically ten. FIG. 1 also shows that typically the OLT 12 is less than 50 km away from the WDM splitter 14; the WDM splitter 14 is typically less than 5 km away from the MUB 16; and the MUB 16 is less than 0.5 km from the user 18.

In this specification a downstream direction means towards the users and away from the core of the network, whereas an upstream direction means away from the users and towards the core of the network.

The OLT 12 has a plurality of tributary channels 20 which are labelled as A₁-A_{M} which communicate with a metropolitan core network. These channels 20 may be provided optically or electronically in a known manner. In this example M is typically 400, such that 400 users 18 can be provided with communications services. The OLT 12 and the WDM splitter 14 are in communication via a downstream optical fibre 22 labelled B₁C₁, and an upstream optical fibre 24 labelled C₂B₂. The WDM splitter 14 and the MUB 16 are in communication via a downstream optical fibre 26 labelled D₁E₁, and an upstream optical fibre 28 labelled E₂D₂. The MUB 16 and the user 18 are in communication via a single bidirectional fibre 30 labelled F₁₁G₁₁. The optical fibre 32 labelled F₁ₖG₁ₖ is for another user (not shown).

FIG. 1 also shows spectral graphs 34, 36, 38, 40 showing the optical signal at various locations in the network 10. The graph 34 shows the optical signal present in the downstream optical fibre 22 between the OLT 12 and the WDM splitter 14 and illustrates that there are 2N WDM channels which are spaced 50 GHz apart. These channels are alternately transmitted in a modulated and an unmodulated format such that the “odd” channels are modulated and contain data, and the “even” channels are unmodulated and do not contain data. A modulated channel is shown at 42, and an unmodulated channel is shown at 44. The optical signal present in the downstream optical fibre 22 is comprised of N modulated channels 42 which are spaced 100 GHz apart, which are interleaved with N unmodulated channels 44 which are spaced 100 GHz apart.

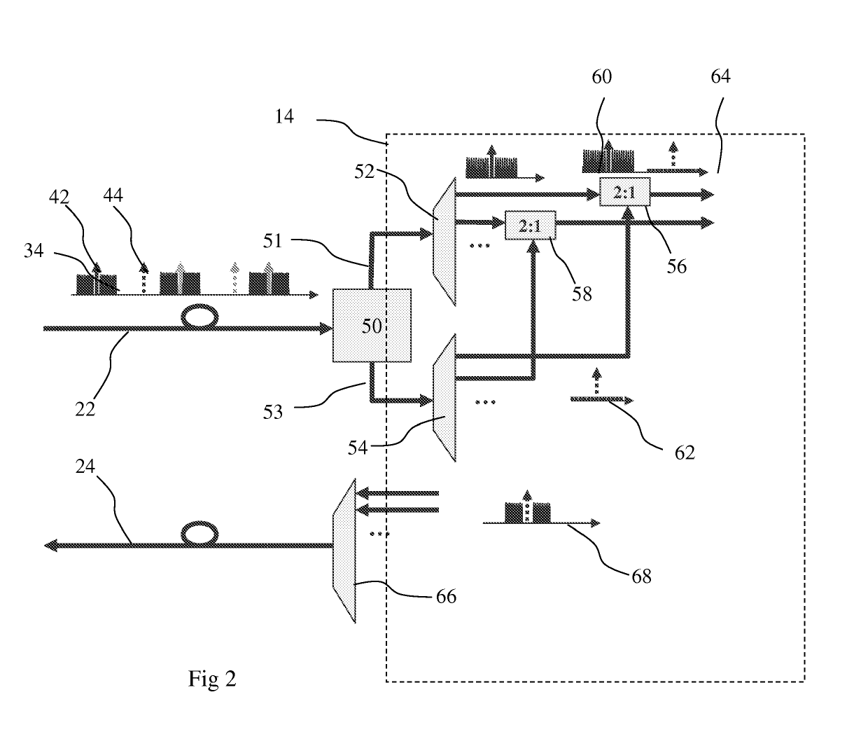

FIG. 1 shows that there are N output ports and N input ports of the WDM splitter 14. The WDM splitter 14 is arranged such that only one modulated channel 42 and the adjacent unmodulated channel 44 are present on each of the output ports as shown in the graph 36. The detailed operation of the WDM splitter 14 to provide this arrangement of signals is shown in FIG. 2.

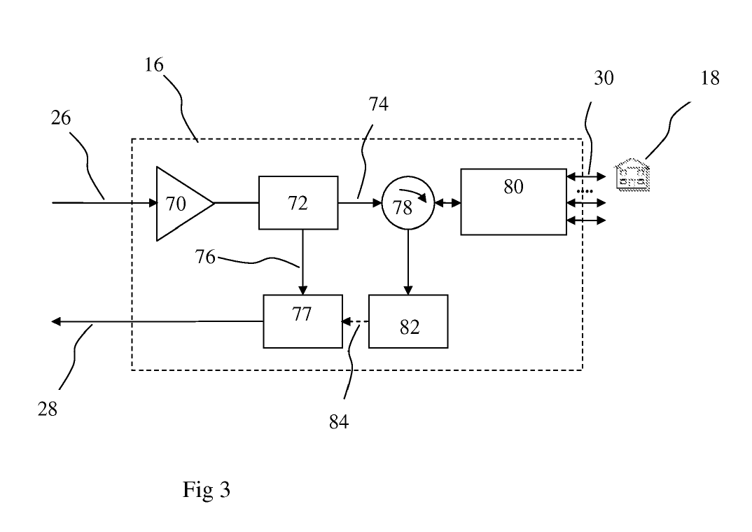

FIG. 1 also shows the graph 38 which illustrates the optical signal present in the optical fibre 28. This optical signal comprises ten user channels from the ten users (one of which is shown at 18) in communication with the MUB 16. The MUB 16 collects these ten user channels and combines them into the modulated signal 38 with the unmodulated carrier 44 shown in the graph 34. The detailed operation of the MUB 16 to provide this functionality is shown in FIG. 3.

FIG. 1 further shows the graph 40 which illustrates a series of modulated optical channels 38, 46 from different MUBs 16. The channels 38, 46 are shown to be 100 GHz apart which corresponds to the 100 GHz spacing of the unmodulated channels 44 on the downstream optical fibre 22. In the upstream direction only modulated channels are sent from the MUB 16 to the OLT 12 through the WDM splitter 14. The carriers for the modulated channels 38, 46 are the unmodulated channels 44 shown in graph 34.

Whilst the connection between the MUB 16 and the user 18 is shown in FIG. 1 to be via an optical fibre, it will be appreciated that this connection could be via radio transmission thereby avoiding the requirement for a physical optical fibre or copper wire to the user 18. It will also be appreciated that the connection between the MUB 16 and the user 18 could be via Sub Carrier Multiplexing (SCM) over fibre or using radio transmission. The skilled person will know how to put such techniques into effect and they will not be described further.

FIG. 2 shows the WDM splitter 14 of FIG. 1 in greater detail. In FIG. 2 the WDM splitter 14 is arranged to separate and rearrange the input channels so that at each output port N there is one modulated channel and one unmodulated channel. The input optical fibre 22 carries the optical signals shown in the graph 34, which comprises the N modulated channels 42 and the N unmodulated channels 44. The combined 2N optical channels are input to a deinterleaver 50 which is a standard optical component having two output arms 51, 53. The deinterleaver 50 separates the modulated channels 40 on one arm 51, and the unmodulated channels 44 on the other arm 53. Each arm 51, 53 is in communication with a respective 100 GHz demultiplexer 52, 54 which operate to separate the channels into individual wavelengths. The demultiplexer 52 having the modulated channels 42 input to it has N outputs to respective 2:1 couplers of which there are only two shown at 56, 58 for the purposes of simplicity. A graph 60 illustrates a typical optical signal at one of the output ports of the demultiplexer 52, and shows one demultiplexed set of wavelengths. Each wavelength of the set of wavelengths shown in the graph 60 is destined for a different user 18. The demultiplexer 54 having the unmodulated channels 44 input to it also has N outputs to the N respective 2:1 couplers 56, 58. A graph 62 illustrates a typical optical signal at one of the output ports of the demultiplexer 54, and shows one set of carrier wavelengths. Each wavelength of the set of carrier wavelengths shown in the graph 62 is destined to carry the traffic from a different user 18. A combined graph 64 illustrates a typical optical signal at one of the output ports of a coupler 56, 58 and shows one demultiplexed set of wavelengths and one set of carrier wavelengths. These two sets of wavelengths are separated by 50 GHz.

In FIG. 2 the WDM splitter 14 has a multiplexer 66 to multiplex incoming data streams from the users 18 and to transmit them upstream via the optic fibre 24. In the upstream direction it is sufficient to use a 100 GHz multiplexer which corresponds to the spacing of the unmodulated channels 44. It will be appreciated by those skilled in the art that in the upstream direction the WDM splitter 14 does not perform any splitting operations. A graph 68 illustrates a typical optical signal at one of the input ports of the multiplexer 66 and shows one set of wavelengths that are transmitted using a respective one set of carrier wavelengths.

The WDM splitter 14 shown in FIG. 2 has been simplified for the purposes of clarity, but it will be understood from the diagram that there are N output ports and N input ports at the right hand side of the diagram. The input and output ports are grouped so that they correspond to each other such that each output port carrying data for a particular set of K user corresponds to a respective input port from a particular set of K users.

FIG. 3 shows the MUB 16 of FIG. 1 in greater detail. Dashes lines represent electrical connections whereas solid lines represent optical connections. In FIG. 3 the input optical fibre 26 to the MUB 16 is from one of the N output ports from the WDM splitter 14 of FIGS. 1 and 2, and carries one demultiplexed set of wavelengths and one set of carrier wavelengths as per the graph 64 shown in FIG. 2. In FIG. 3 the MUB 16 firstly amplifies the input optical signal with an optical amplifier 70, which may be a conventional Erbium Doped Fibre Amplifier (EDFA) or a Semiconductor Optical Amplifier (SOA). The MUB 16 then operates to separate the demultiplexed set of wavelengths from the set of carrier wavelengths using a MUB deinterleaver 72 which has two output arms 74, 76. The MUB deinterleaver 72 separates the demultiplexed set of wavelengths on one arm 74, and the set of carrier wavelengths on the other arm 76. The arm 76 having the carrier wavelengths is in communication with an optical modulator 77. The arm 74 carrying the demultiplexed set of wavelengths is in communication with an optical circulator 78 which in turn communicates with a 1:K optical splitter 80. The optical circulator 78 broadcasts the demultiplexed set of wavelengths to the user 18 via the 1:K optical splitter 80 and the optic fibre 30. Each user tunes to one wavelength to receive and transmit data on that wavelength only. It will be appreciated that no high frequency stability is required to be applied to the wavelength that the user tunes in to. It is sufficient for operational purposes that the individual wavelengths corresponding to different users are always kept separated, at a distance greater than the receiver bandwidth. It will also be appreciated that only one user 18 is shown but the optical splitter 80 has a respective optic fibre for each user connected to it.

The optical fibre 30 is bidirectional for transmission of data in the upstream and downstream directions. In the upstream direction the user 18 transmits data via the optic fibre 30 to the 1:K optical splitter 80 which operates to receive and combine wavelengths from K different users using the optical circulator 78. The optical circulator 78 passes the K upstream wavelengths to an Optical to Electrical (OE) converter 82. The OE converter 82 has a photodetector (not shown) to detect the upstream wavelengths from the users 18 to obtain an electrical signal illustrated at 84. This electrical signal 84 is input to the optical modulator 77 where it is used to modulate the carrier wavelengths received from the MUB deinterleaver 72. A modulated optical signal is then transmitted upstream via the optical fibre 28.

In the upstream direction the wavelengths from the K users are combined by the optical splitter 80 such that the frequency separation between wavelengths of different users is higher than the bandwidth of the photodetector in the OE converter 82. This ensures that the photodetector can handle the data from the users. Furthermore, the frequency separation between the wavelengths from the users must be sufficiently (i.e. more than the modulating signal bandwidth) so that the wavelengths from the users do not overlap in the combined signal output on optical fibre 28.

Using carrier wavelengths transmitted in a downstream direction to transmit user data in the upstream direction avoids the need for a laser, such as a tuneable and frequency-stable laser, and other optical components at the user location. Such optical devices are expensive, add complexity and generally add to the component count of the network which increases the likelihood that breakdowns will occur. Eliminating the need for a laser with demanding frequency stability performance, and other optical components at the user location reduces costs and complexity in the network equipment, and may improve the reliability of the network.

It will be appreciated that the downstream communication between the OLT 12 and the WDM splitter 14 may be provided on the single downstream optical fibre 22, whereas the upstream communication between the OLT 12 and the WDM splitter may be provided on a single upstream optical fibre 24.

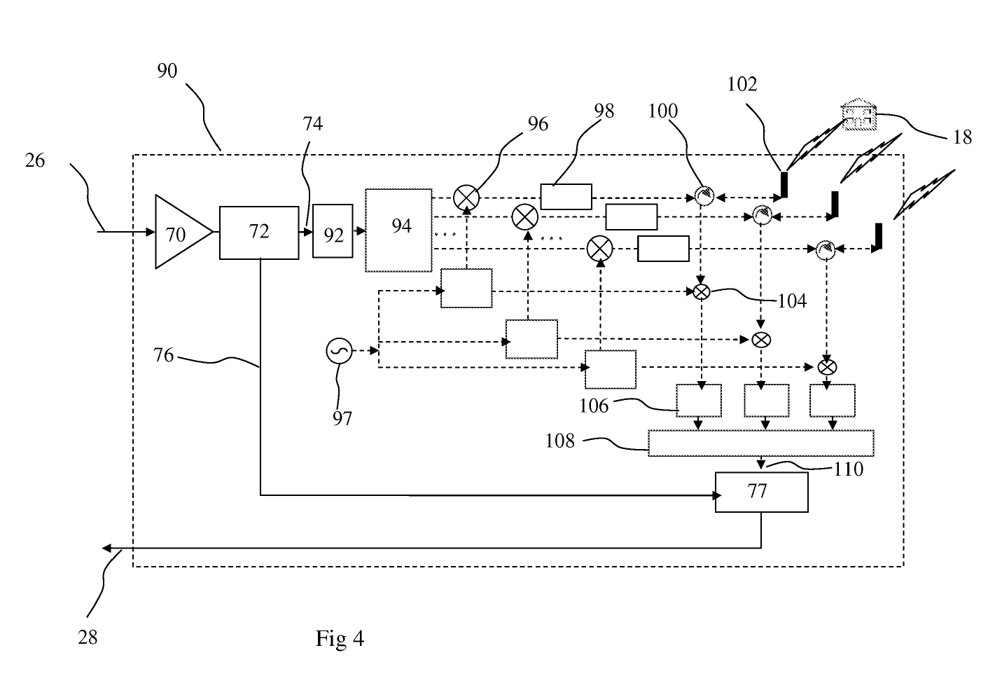

FIG. 4 shows a Multi User Box for use in the network of FIG. 1 according to an alternative embodiment generally labelled 90. Like features to the embodiment of FIG. 3 are shown with like reference numerals. In FIG. 4 dashes lines represent electrical connections whereas solid lines represent optical connections. Whereas the MUB of FIG. 3 is for delivering communications services to users via optic fibres, the MUB 90 of FIG. 4 is for delivering communications services to users via radio transmission. The input optical fibre 26 to the MUB 90 is from one of the N output ports from the WDM splitter 14 of FIGS. 1 and 2, and carries one demultiplexed set of wavelengths and one set of carrier wavelengths as per the graph 64 shown in FIG. 2. The MUB 90 firstly amplifies the input optical signal with an optical amplifier 70 such as an EDFA. The MUB 90 then operates to separate the demultiplexed set of wavelengths from the set of carrier wavelengths using a MUB deinterleaver 72 which has two output arms 74, 76. The MUB deinterleaver 72 separates the demultiplexed set of wavelengths on one arm 74, and the set of carrier wavelengths on the other arm 76. The arm 76 with the carrier wavelengths is in communication with an optical modulator 77. The arm 74 with the demultiplexed set of wavelengths is in communication with an OE converter 92 which in turn communicates with a 1:K electrical splitter 94. To separate the wavelengths corresponding to different users, each output of the 1:K electrical splitter 94 is converted to a radio frequency by a respective downstream Radio Frequency (RF) mixer 96 and a downstream Band Pass Filter (BPF) 98. It will be appreciated that there is one downstream RF mixer 96 and one downstream BPF 98 per user 18. A local oscillator frequency at the downstream RF mixer 96 is provided by a reference frequency from a frequency oscillator 97 common to all of the downstream RF mixers 96. Each wavelength corresponding to a different user is then sent to a duplexer 100 and then to an antenna 102. Each antenna 102 also has an input amplification stage not shown in the Figure.

In the upstream direction a user 18 transmits data to the antenna 102 where it is passed to the associated duplexer 100. The duplexer 100 operates to separate the upstream and downstream signals and then passes the data from the user 18 to an upstream RF mixer 104. A local oscillator frequency at the upstream RF mixer 104 is provided by a reference frequency from the frequency oscillator 97 common to all of the upstream RF mixers 104. The upstream RF mixer 104 converts the signal from a radio frequency and then passes it to an upstream BPF 106 which in turn passes it on to a K:1 electrical coupler 108. The combined electrical signal shown at 110 is input to the optical modulator 77 where it is used to modulate the carrier wavelengths received from the MUB deinterleaver 72. A modulated optical signal is then transmitted upstream via the optical fibre 28. The MUB 90 is able to provide a 1 Gbit/s connection to each user, which is achievable using 60 GHz radio techniques.

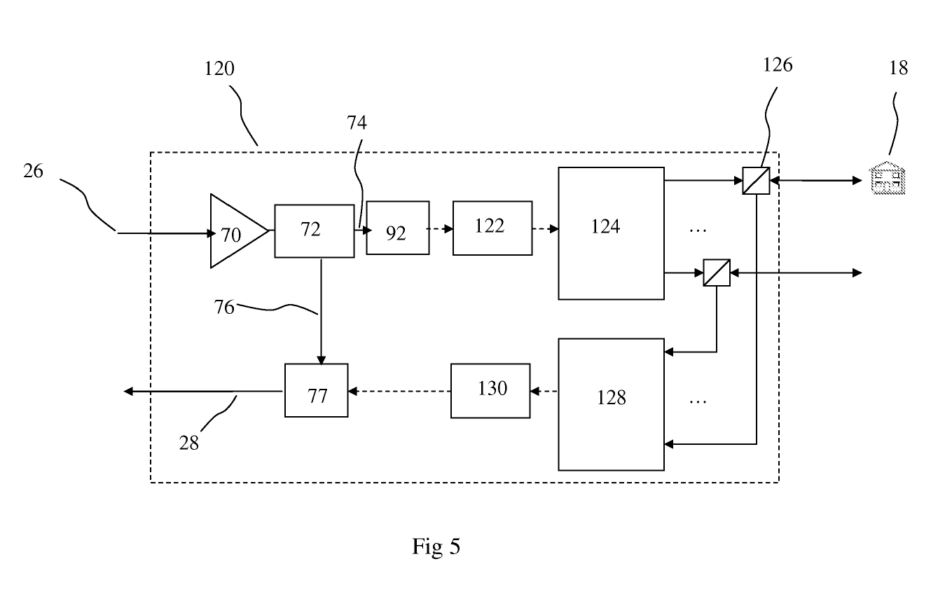

FIG. 5 shows a Multi User Box for use in the network of FIG. 1 according to an alternative embodiment generally labelled 120. Like features to the embodiments of FIGS. 3 and 4 are shown with like reference numerals. In FIG. 5 dashes lines represent electrical connections whereas solid lines represent optical connections. Whereas the MUB of FIG. 4 is for delivering communications services to users via radio transmission, the MUB 120 of FIG. 5 is for delivering communications services to users via a WDM Time Division Multiplexing (TDM) PON.

The input optical fibre 26 to the MUB 120 is from one of the N output ports from the WDM splitter 14 of FIGS. 1 and 2, and carries one demultiplexed set of wavelengths and one set of carrier wavelengths as per the graph 64 shown in FIG. 2. The MUB 120 of FIG. 5 firstly amplifies the input optical signal with an optical amplifier 70 such as an EDFA. The MUB 120 then operates to separate the demultiplexed set of wavelengths from the set of carrier wavelengths using a MUB deinterleaver 72 which has two output arms 74, 76. The MUB deinterleaver 72 separates the demultiplexed set of wavelengths on one arm 74, and the set of carrier wavelengths on the other arm 76. The arm 76 with the carrier wavelengths is in communication with an optical modulator 77. The arm 74 with the demultiplexed set of wavelengths is in communication with an OE converter 92 which in turn communicates with a Forward Error Correction (FEC) Decoder 122 which regenerates the 10 Gbit/s signal in the electronic domain. The signal is then passed to a TDM demultiplexer 124 which processes the signal to obtain individual optical data streams for the users 18, for example ten 1 Gbit/s data streams. The TDM demultiplexer 124 is a static router which allows user Media Access Control (MAC) addresses to be routed to the correct user 18. The data stream for each user is sent via an optical circulator 126. It will be appreciated that there is one optical circulator 126 per user 18.

In the upstream direction a user 18 sends data to the optical circulator 126 which operates to separate the upstream and downstream signals, and then passes the data from the user 18 to a TDM multiplexer 128. TDM multiplexer 128 converts the combined optical signals into the electrical domain and then passes them on to a FEC encoder 130. The FEC encoder 130 outputs the electrical signal to the optical modulator 77 where it is used to modulate the carrier wavelengths received from the MUB deinterleaver 72. A modulated optical signal is then transmitted upstream via the optical fibre 28.

The advantages of the above-described embodiments are that the propagation penalty arising from upstream and downstream optical signal propagation in the same optical fibre used in a convention PON or WDM PON is eliminated. Furthermore the equipment at or near to the user location is simplifier which has an associated advantage of being less expensive to implement and may also be more reliable. Since the optical equipment is simplified, conventional EDFAs can be used to enhance the link distance. Such EDFAs are low cost and may greatly improve the system performance.

Another advantage of the present embodiments is that the number of connected users is dramatically increased when compared to a conventional PON. The present embodiments envisages up to 400 users connected to the OLT whereas the conventional PON typically connects 64 users to the OLT. This is due in part to the more efficient use of bandwidth using the techniques of the present invention, and the fact that there are dedicated optic fibres 22 and 24 for communication in the downstream and upstream directions respectively between the OLT 12 and the WDM multiplexer 14.

It will be appreciated that the above-described embodiments in FIGS. 1-5 is adaptable to TDM and SCM signal formats. The embodiments are described for use with WDM but it will also be appreciated that this is a general term which encompasses Dense WDM (DWDM), and the skilled person will know how to operate the invention for DWDM based on the description for implementation with WDM. The embodiments are described for use with a standard bidirectional user interface, such as a single optic fibre carrying upstream and downstream data, but it will be understood that these interfaces could be unidirectional interfaces, such as an optical fibre carrying upstream data and an optic fibre carrying downstream data.

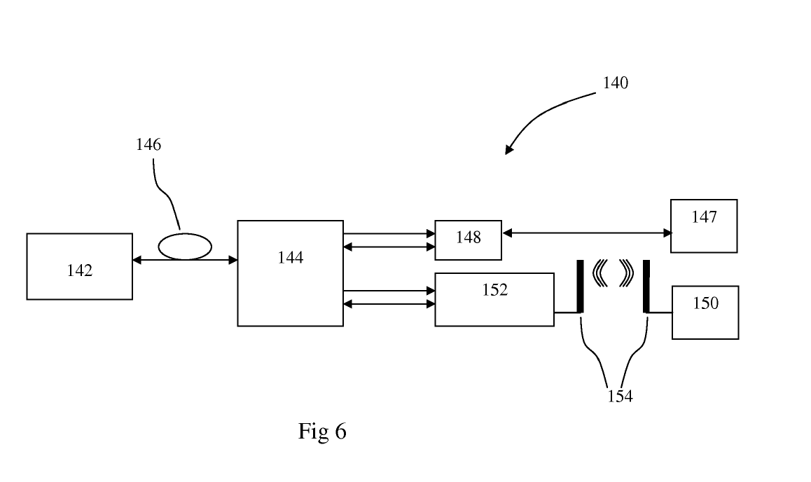

In an alternative arrangement to the embodiments of FIGS. 1-5, FIG. 6 shows a network according to an embodiment of the invention, generally designated 140. The network 140 comprises a Central Office (CO) node 142, also known as an Optical Line Termination (OLT) node, in communication with a Wavelength Division Multiplexing (WDM) distribution node 144 via a single optical fibre 146. Such a single optical fibre 146 is advantageous because the upstream and downstream signals share the same fibre and thereby maximize the system efficiency whilst keeping costs to a minimum. The WDM distribution node 144 is in communication with a user 147 via an Optical Network Termination (ONT) 148, or in communication with a user 150 via a radio interface 152 via an antenna 154. FIG. 6 has been simplified for the purposes of clarity to show one ONT 148, and one radio interface 152 but it will be appreciated that in the real world example, there may be N such ONTs 148 and radio interfaces 152 where each ONT 148 or radio interface 152 serves a respective user. In this example N is typically forty. Each ONT 148, or radio interface 152 is a single user device. In FIGS. 6-12 optical connections are represented as arrows.

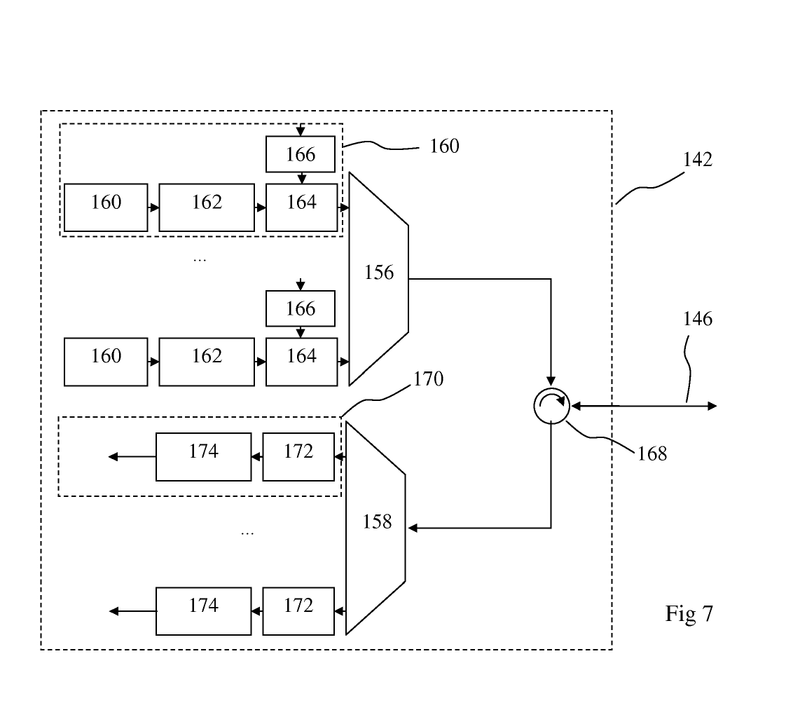

FIG. 7 shows a central office node for use in the network 140 of FIG. 6, generally designated 142. The node 142 comprises a WDM multiplexer 156 for transmission of traffic in the downstream direction, and a WDM demultiplexer 158 for onward transmission of traffic in the upstream direction. The WDM multiplexer 156 and the WDM demultiplexer 158 may be Array Waveguide Gratings (AWG). In order to realise the WDM multiplexer 156 an optical filter is required to have a free spectral range matching the selected WDM allocation and AWG spacing according to known techniques. N tributary modules 160 are provided for transmission of traffic in the downstream direction which all input to the WDM multiplexer 156. Each tributary module 160 is capable of transmitting a 10 Gb/s signal and comprises a laser 160 which has an output to an Optical Single Side Band (OSSB) modulator 162. The OSSB modulator 162 has an output to a Radio Frequency (RF) converter 164 which outputs to the WDM multiplexer 156. The RF converter 164 is modulated by a baseband modulator 166 and the signals from each tributary module 160 are multiplexed by the WDM multiplexer 156.

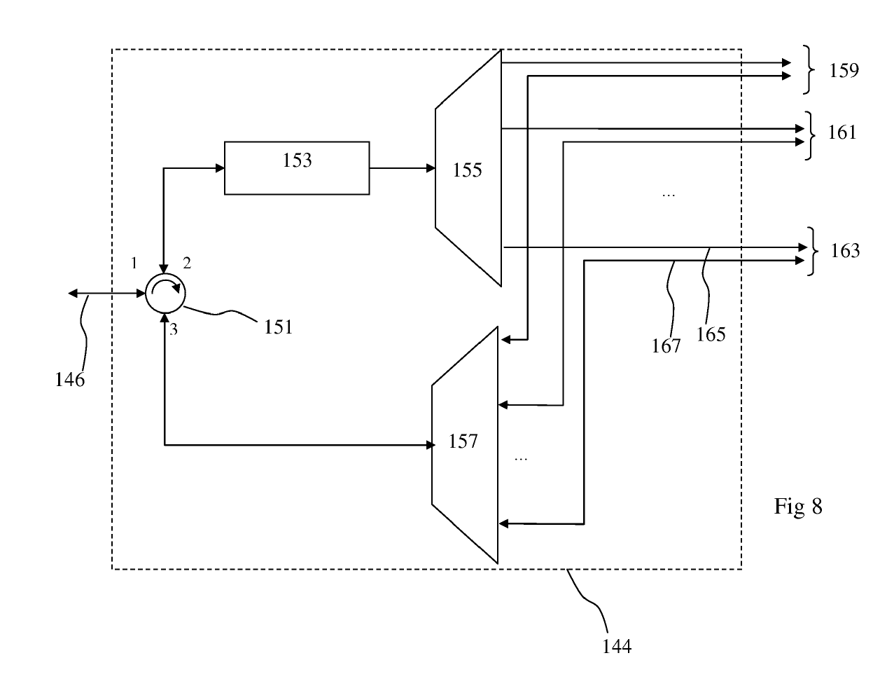

The OSSB modulator 162 removes one of the side bands that are output from the laser 160 e.g. a left hand side band. The OSSB modulator 162 may be, for example a dual arm Mach-Zender Modulator where a modulated signal is input on one arm, and a phase-shifted modulated signal is input on the other arm. The modulated signals input to each arm are the same apart from one being phase-shifted relative to the other. The phase shift may be +π/2 to achieve the required OSSB modulated output. Using OSSB modulation to remove the left hand side band makes it easier to separate the right hand side band from the carrier frequency as discussed below with reference to FIG. 8.

In FIG. 7 each laser 160 is intensity modulated by a conventional Non-Return to Zero (NRZ) format. Alternatively a more complicated multi-level modulation format can be used which would provide higher spectrally efficiency and allow network capacity upgrades to be performed more easily. The RF conversion is performed by the RF converter 164 around a frequency f_{RF}. If a radio user 150 is connected to the network 10 then f_{RF} is set to be a radio transmission frequency of 60 GHz. Regardless of whether a radio user 150 is connected to the network 10, f_{RF} is required to be higher than the base bandwidth of the modulated signal so that it is possible to separate the optical carrier and the modulated signal in the WDM distribution node 14 shown in FIG. 8. Typically f_{RF} may be about 1.5 times higher than the base bandwidth to allow separation of the optical carrier and the modulated signal.

In FIG. 7 the WDM multiplexer 156 has an output to an optical circulator 168 which in turn has an output to the optical fibre 146 shown in FIG. 6. In FIG. 7 the optical circulator 168 can also receive WDM traffic in the upstream direction from the optical fibre 146 which is input to the WDM demultiplexer 158. This receiving part of the CO node 30 operates as per a conventional WDM Passive Optical Network (PON), whereby the WDM stream is separated by the WDM demultiplexer 158. Each stream is then output to a respective receiver module 170 which comprises a photodetector 172 and a baseband receiver 174. In this example there are N receiver modules 170.

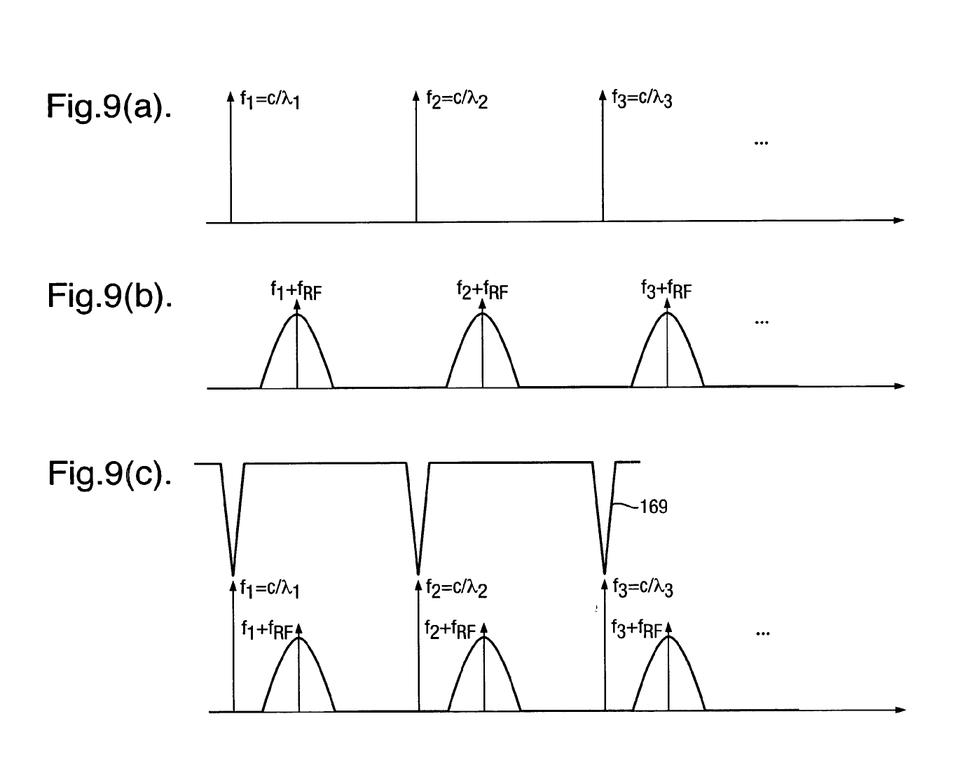

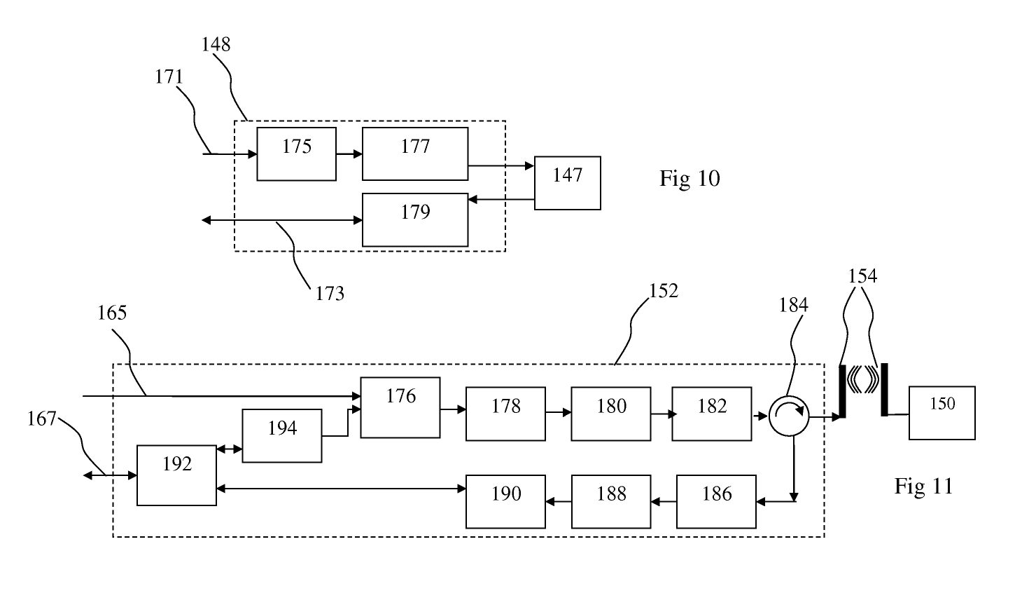

FIG. 8 shows a WDM node for use in the network of FIG. 6, generally designated 144. The optical fibre 146 is shown connected to an optical circulator 151 of the WDM distribution node 144. One port of the optical circulator 151 outputs to an optical periodic notch filter 153 which is, for example a grating. The optical periodic notch filter 153 operates to pass the modulated RF part of the optical signal on to a traffic WDM demultiplexer 155, and to reflect all of the carrier frequencies back to the optical circulator 151. The carrier frequencies are then output from the optical circulator 151 to a carrier WDM demultiplexer 157. The outputs of traffic WDM demultiplexer 155 and the carrier WDM demultiplexer 157 are arranged so that respective pairs of optical fibres carrying RF signals and carrier frequencies are grouped together as shown at 159, 161 and 163. These pairs of optical fibres are in communication with a respective ONT 148 or a radio interface 152 as shown in FIGS. 10 and 11. It will be appreciated that the optic fibre pairs 159, 161, 163 may alternatively be respective Arrayed Waveguide Gratings. It will also be appreciated with reference to FIG. 9 that the optical fibres 165 from the traffic WDM demultiplexer 155 transmits RF traffic in the downstream direction only, whereas the optical fibres 167 of the carrier WDM demultiplexer 157 transmit carrier frequencies in the downstream direction and modulated carrier frequencies containing data in the upstream direction. The optical fibre between the optical circulator 151 and the carrier WDM demultiplexer 157 transmits carrier frequencies in the downstream direction and modulated carrier frequencies in the upstream direction.

FIG. 9 shows three graphs (a), (b) and (c) illustrating the operation of the periodic notch filter 153. Each graph has an x-axis showing frequency and a y-axis showing amplitude. In the graphs the constant c is the speed of light. Graph (a) shows three carrier frequencies f₁, f₂, and f₃ that are reflected to the circulator 151 by the optical periodic notch filter 153. These carrier frequencies are the frequencies of light emitted by the lasers 160 in FIG. 7. In FIG. 9 only three carrier frequencies are shown in graph (a), but it will be appreciated that there would be N such reflected carrier frequencies.

Graph (b) of FIG. 9 shows three RF data signals f₁+f_{RF}, f₂+f_{RF}, and f₃+f_{RF} that have been separated from their respective carrier frequency f₁, f₂, and f₃ and transmitted by the optical periodic notch filter 153 to the traffic WDM demultiplexer 155. Only three RF data signals are shown in graph (b), but it will be appreciated that there would be N such RF data signals transmitted.

Graph (c) shows the combined graphs (a) and (b) which is the WDM spectrum transmitted by the CO node 142 in the downstream direction on the optical fibre 146.

Only three combined RF data signals and carrier frequencies are shown in graph (c), but it will be appreciated that there would be N such combined signals transmitted. The top part of graph (c) also shows a transmission response 169 of the optical periodic notch filter 153.

FIG. 10 shows an Optical Network Termination (ONT) according to an embodiment of the invention, generally designated 148. The ONT 148 receives a RF data signal, for example f₁+f_{RF}, via the optical fibre 171 from the traffic WDM demultiplexer 155 of FIG. 8. This RF data signal is input to a photodetector 175 and then to a baseband receiver 177 of the ONT 148 before being passed on to the user 147. It will be appreciated that the arrangements described allow the photodetector 177 to be used in place of using a dedicated local oscillator to perform conversion into the electrical domain. This allows the provisioning of different levels of Quality of Service, for example implemented by using different multilevel formats for each ONT 148, which may allow network upgrades to be implemented more easily. It will also be appreciated that the photodetector 177 is only required to have a bandwidth equal to the signal bit-rate and not the bandwidth associated with the carrier frequency, which simplifies the ONT 148 and reduces the overall costs. An advantage of this is that each ONT 148 is able to receive downstream traffic over different carrier frequencies, as long as the filtered side-band is outside of the optical periodic notch filter 153 rejection bandwidth. This allows colourless operation of the ONT 148 which has the advantage of simplifying network architecture and reducing costs. Furthermore the choice of OSSB modulation avoids the fading effect due to chromatic dispersion at different carrier frequency tones even over comparatively long distance PONs.

In the upstream direction the user 147 transmits data, for example a 10 Gb/s data stream, which is used to modulate an injection current of a Reflective Semiconductor Optical Amplifier (RSOA) 179. The carrier frequency sent in the downstream direction on the optic fibre 167, for example f₁ shown in FIG. 9b, is passed to the RSOA 179. The RSOA 179 is capable of receiving the carrier frequency f₁ and reflecting it back in the upstream direction in a modulated form corresponding to the modulation of the injection current. In this way the downstream carrier frequency is used to provide a modulated upstream signal, which avoids the requirement for a carrier frequency generator, such as a laser, at the ONT 148 or the user location 147.

FIG. 11 shows a radio interface termination according to an alternative embodiment, generally designated 152, which is an alternative arrangement to FIG. 10 for connecting a radio user 150 to the WDM distribution node 144 of FIG. 8. In FIG. 11 the radio interface termination 152 receives a RF data signal, for example f₁+f_{RF} shown in FIG. 9b, via the optical fibre 165 from the traffic WDM demultiplexer 155 of FIG. 8. This RF data signal is input to a 2:1 optical coupler 176 which outputs to a photodetector 178 which in turn outputs to a band pass filter 180. The band pass filter 180 selects the RF data signal centred around f_{RF} which it outputs to a RF power amplifier 182 to improve the signal before outputting it to a microwave circulator 184. The microwave circulator 184 passes the signal on to the antenna 154 for communication to the user 150. In the upstream direction the user 150 transmits data, for example a 10 Gb/s data stream, to the antenna 154 which is input to the microwave circulator 184. The microwave circulator 184 outputs the signal to a RF low noise amplifier 186 which outputs to a RF envelope detector 188 which performs a baseband conversion of the signal and which is further used to modulate an injection current of a Reflective Semiconductor Optical Amplifier (RSOA) 190. The carrier frequency sent in the downstream direction on the optic fibre 167, for example f₁, is input to a 1:2 optical splitter 192 which passes the carrier frequency to the RSOA 190, and to an optical isolator 194. In effect the carrier frequency and the RF data signal are recombined at the 2:1 optical coupler 176 which is necessary so that there is a reference signal to compare with the RF data signal. The optical isolator 194 passes the signal to the 2:1 coupler 176. The RSOA 190 receives the carrier frequency and reflects it back in the upstream direction in a modulated form corresponding to the modulation of the injection current. In this way the downstream carrier frequency is used to provide a modulated upstream signal, which avoids the requirement for a carrier frequency generator, such as a laser, at the radio interface 152 or user location 150. One advantage of the radio interface termination 152 is that using a modulated RF signal sent from the CO node 142 of FIG. 7 eliminates the need for RF conversion at the radio interface termination 152 to allow transmission by the antenna 154. This is because the signal is already at a radio frequency.

In the upstream direction the modulated carrier frequency transmitted from the ONT 148 of FIG. 10, or the radio interface termination 152 of FIG. 11, is sent to the WDM distribution node 144 of FIG. 8. The modulated carrier frequency is input to the WDM demultiplexer 157 which operates as a multiplexer in the upstream direction to combine data streams from many users. The multiplexed upstream signal is then passed on to the optical circulator 151 of the WDM distribution node 144 where it is output to the optical fibre 146 which is in communication with the optical circulator 168 of the CO node 142 of FIG. 7. The optical circulator 168 outputs to the WDM demultiplexer 158 which separates the individual modulated signals on respective receiver modules 170 for onward transmission.

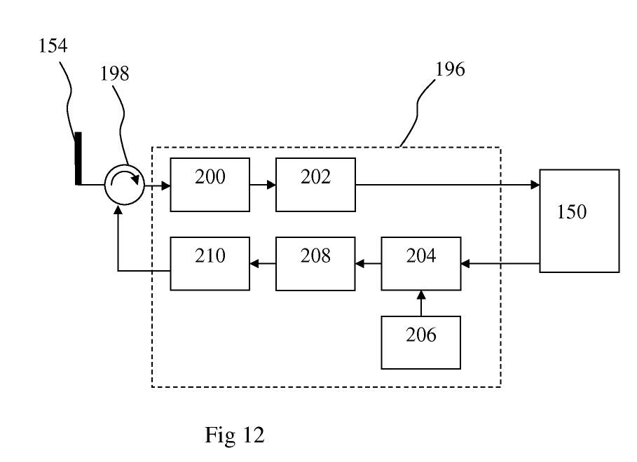

FIG. 12 shows a user radio interface for use with the radio interface termination of FIG. 11, generally designated 196. In FIG. 12 the antenna 154 receives a RF data signal which is input to a microwave circulator 198 and then passes it on to a RF low noise amplifier 200. The RF low noise amplifier 200 in turn passes the signal to an envelope detector 202 which demodulates the signal before passing it on to the user 150. In the upstream direction the user sends a data signal which is converted to f_{RF} by a RF mixer 204 and a RF local oscillator 206. The modulated RF signal is then passed to a RF filter 208 which improves the signal before it is sent to a RF power amplifier 210. The RF power amplifier 210 then passes the signal to the microwave circulator 198 for onward transmission by the antenna 154.

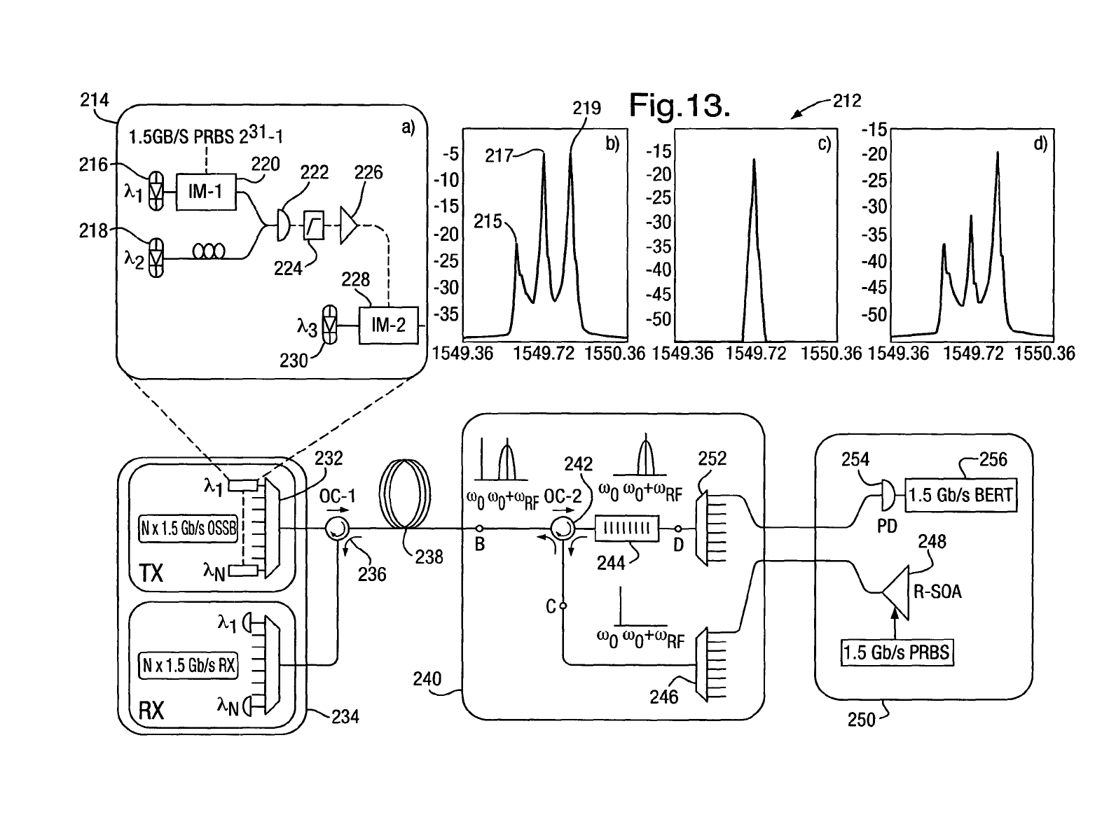

FIG. 13 shows an experimental setup for the architecture of FIGS. 6-8 and 10, generally designated 212. The graphs (b), (c) and (d) in FIG. 13 show optical spectra recorded at 0.1 nm resolution bandwidth at respective parts B, C and D in the experimental setup, and illustrate optical power on the y-axis in dBm and wavelength on the x-axis in nm. The experimental setup shows an optical circuit 214 to generate the downstream OSSB signal instead of the laser 160, OSSB modulator 162, RF converter 164 and baseband modulator 166 shown in the CO node 142 of FIG. 7. In FIG. 13 the optical circuit 214 uses two independent lasers 216, 218 separated by 20 GHz (λ₁=1548.68 nm, X₂=1548.52 nm). One of the lasers 216 was intensity modulated by a LiNbO3 intensity modulator (IM-1) 220 driven by a NRZ 2³¹-1 bit-long Pseudo Random Bit Sequence (PRBS) at 1.5 Gb/s. The two optical signals were coupled into a 40 GHz wide-band photodiode 220 which acted as an up-converter for the 1:5 Gb/s signal. The obtained electrical signal was then filtered by an electrical high-pass filter 224 and amplified by an electrical amplifier 226 to drive a LiNbO3 single drive intensity modulator (IM-2) 228 which imparted the desired modulation over a third laser 148 at λ₃=1549.72 nm. The electrical high-pass filter 224, with 3 dB cut-off at 2.5 GHz was used in order to erase the base-band spectrum created by the mixing process at the photodiode 222. In order to obtain a true OSSB signal, an optical narrow-band notch filter was used to strongly attenuate one of the optical side-bands of about 20 dB (not shown in the optical circuit 214 to improve clarity).

The optical spectrum of the obtained OSSB signal at point B is shown in the inset graph (b) which shows three spikes 215, 217, 219. The spike 215 represents the unwanted sideband, the spike 217 represents the carrier frequency, and the spike 219 represents the desired modulated sideband. The relative power of the optical carrier and the selected side-band was tuned by biasing the modulator 228.

The OSSB signal from the optical circuit 214 was input to an Array Waveguide Grating 232, operating as a multiplexer, of an experimental Central Office node 234, and by means of an optical circulator (OC-1) 236 it was launched into a feeder optical fibre 238. In the experimental arrangement of FIG. 13 the feeder optical fibre was a Single Mode Fibre (SMF-28) which had about 6 dB of total losses and was 26 km in length. At an experimental distribution node 240 the downstream signal was passed through an optical circulator (OC-2) 242 and then fed into a periodic reflective optical notch filter 244. This periodic reflective optical notch filter 244 was a fibre Bragg grating with a 6 GHz Full Width Half Maximum (FWHM) single channel bandwidth Δω, a peak-reflectivity of 99%, and a periodicity P of 100 GHz. The periodic reflective optical notch filter 244 had rejection bands that matched the WDM allocation of the AWGs 232. The laser 230 has an output λ₃ that was tuned in order to be centred with only one rejection window. The signal reflected back by the periodic reflective optical notch filter 244 comprised only the carrier from the downstream signal prior to remodulation as shown in the inset graph (c). The periodic reflective optical notch filter 244 operated to allow the RF tone centred at 20 GHz to pass through unaffected as shown in the inset graph (d) which shows the signal at point D in the experimental setup after the periodic reflective optical notch filter 244. The effect of the sideband suppression can also be seen in inset graph (d).

After being coupled through optical circulator (OC-2) 242 and an AWG 246 of the distribution node 240 operating as a demultiplexer, the optical carrier λ₃ was delivered to the RSOA 248 of an experimental ONT 250. The RSOA 248 was a commercially available device, providing 22 dB small signal gain with less than 1 dB polarization dependent gain, and 3 dBm output saturation power. The RSOA 248 was biased at 70 mA and driven by a NRZ 2³¹-1 bits-long PRBS at the highest supported bandwidth of the RSOA 164, i.e. 1.5 Gb/s.

The OSSB signal carrying the downlink data at point D in FIG. 13 was then routed to a further AWG 252 of the experimental WDM distribution node 240, and then on to the ONT 250 where it was received by a photodiode 254. According to the filter specifications, the optical carrier had a transmittance of 1% and was still present at the photodiode 254, even if strongly attenuated as shown in the inset graph (d) of FIG. 13. It was discovered that the filtering process performed by the period optical notch filter 244 was effective as long as the OSSB signal carrying data is placed over a RF tone such that Δω<ω_{RF}<P, without requiring any change at the photodiode 254 of the ONT.

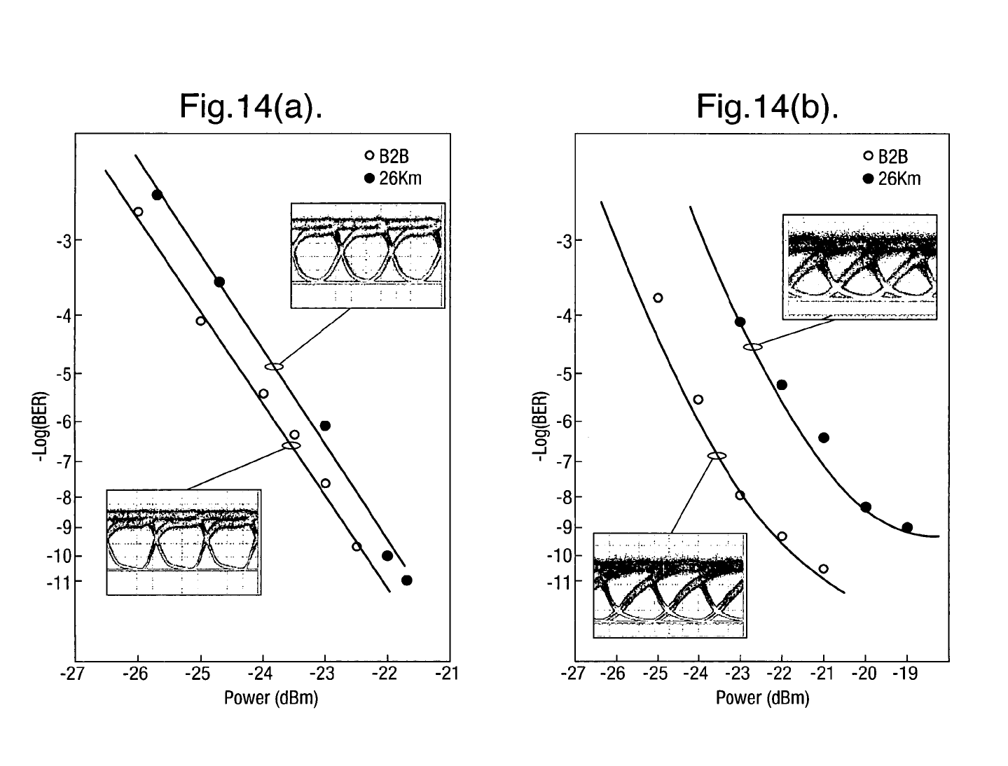

The photodiode 254 of the ONT is a high speed photo-receiver which is followed by an electrical low-pass filter 256. The same type of receiver was also used at the CO node 234 to determine the uplink performance. The overall performance of the experimental network 212 was determined by Bit Error Rate (BER) measurements for back-to-back (B2B) and after transmission over the feeder fibre 238 for both the uplink and downlink as shown in FIG. 14. The B2B measurements refer to measurements taken without an optical fibre but with an equivalent optical attenuator to obtain the same received optical power.

FIG. 14a shows the performance of the experimental arrangement 212 of FIG. 13 in the downstream direction. FIG. 14a shows that there was less than 0.3 dB power loss after transmission through the feeder fibre 238. Two eye diagrams inset in FIG. 14a show that the downlink signal was affected by some noise but this was only of an amplitude of the order of magnitude shown on the scale of the graph. This was most likely due to the incoherent beating noise generated at the wide-band photodiode 222 used in the optical circuit 214 because it is evident from FIG. 13d that the optical carrier is not totally suppressed at the WDM distribution node 240, and a residual beating noise is still present. It will be appreciated that in a real world OSSB generator featuring an electrical up-converter and a low phase-noise oscillator should minimise such residual beating noise.

FIG. 14b shows the uplink performance which was limited by two factors. First, the limited bandwidth of the available RSOA 248 in the experimental setup 212 which was slightly less than 1:5 Gb/s. As shown in FIG. 14b, the back-to-back eye diagram measured at the RSOA 248 output shows a very low crossing point which resulted in a 1 dB power loss penalty if compared to an ideal NRZ signal at the same bit-rate. The other limiting factor was the Rayleigh scattering which introduced about 3 dB power loss penalty and imposed a BER floor after propagation over the 26 km feeder fibre 238. The effect of the back scattering was of an amplitude of the order of magnitude shown on the scale of the graph in the uplink signal which is noisier when compared to the back-to-back graph. This penalty would appear to be unavoidable if a single fibre optic feeder architecture is adopted. However, considering that there are about 16 dB total link losses (comprised of 4 dB at each AWG, 1 dB at each circulator, and 6 dB to the feeder fibre) and that about 20 dB gain is provided by the RSOA 248, there is about 4 dB of margin in order to keep the system below the 10-9 error rate regime. This applies both in downlink and uplink when the optical carrier and the OSSB signal have the same optical power. It will be appreciated that this margin can be increased by simply biasing the intensity modulator 228 in order to provide a higher power of the carrier frequency with respect to the OSSB signal without resorting to additional optical amplifiers. If the modulation index of the downstream optical signal is too high it can cause considerable cross-talk in the upstream direction, which affects the uplink performance. However, if the downstream modulation index is reduced the downlink performance will be affected. Using OSSB modulation has the advantage of allowing a high downstream modulation index to be used which minimises the cross-talk between the downstream and upstream optical signals.

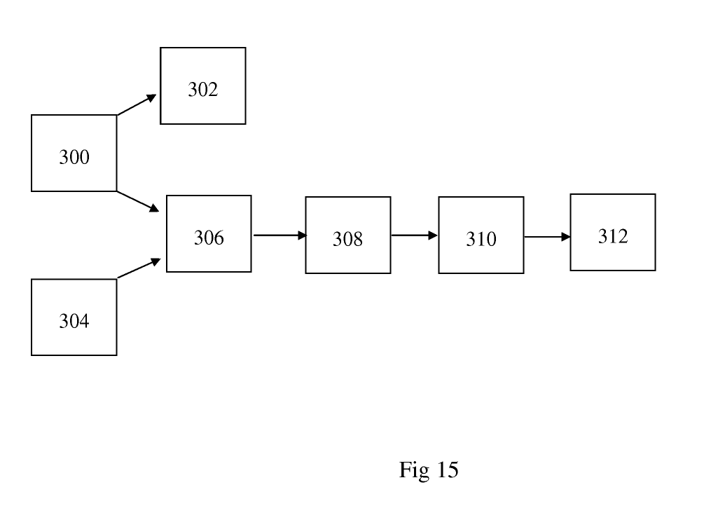

FIG. 15 shows a flow diagram illustrating a method according to an embodiment of the present invention. The method relates to operation of a communications network for providing communications services to at least one user. The method includes transmitting 300 an optical signal comprising at least one Wavelength Division Multiplexing channel in a downstream direction, at least one of the channels being an unmodulated channel. The method further includes using 302 the unmodulated channel to transmit user data from the at least one user in the upstream direction. The method may also include transmitting 304 at least one modulated channel in the optical signal.

If the optical signal includes an unmodulated and a modulated Wavelength Division Multiplexing channel the method includes demultiplexing 306 the modulated Wavelength Division Multiplexing channel, and separating 308 the modulated channel from the unmodulated channel. The method may include associating 310 a separated modulated channel with a separated unmodulated channel, and transmitting 312 the associated modulated and unmodulated channels in the downstream direction.

The above embodiments describe a WDM-PON which uses a downstream signal based on OSSB modulation at a radio frequency detected by means of narrow band filtering, and performed at the WDM distribution node 144. This has the advantage of avoiding the requirement for the downstream traffic to be down-converted from the optical domain into the electrical domain at the WDM distribution node 144. Furthermore extracting the downstream carrier frequency at the WDM distribution node 144 and remodulating it at the ONT 148 has the advantage of allowing full-duplex and symmetric bandwidth operation of the WDM-PON in the downstream and the upstream directions. In addition, the above described WDM-PON allows a colourless and polarisation independent ONT 148 to be used because all optical filtering is performed at the WDM distribution node 144. Such filtering allows the downstream modulation signal to be sent with a full modulation index which advantageously provides an improved modulated signal. Using a RF modulated signal in the downstream direction means that the receiver at the ONT 148 is not required to support the RF tone bandwidth, and is only required to support the bandwidth of the modulating signal.

It will be appreciated that an advantage of the above described embodiments is that no lasers are required at the ONT 148 or the radio interface 152. Furthermore since the downstream data signals are transmitted in the RF range the radio interface 152 allows radio users 150 to be connected to the CO node 142 without requiring complicated RF design (e.g RF local oscillators and mixers for frequency conversion) at the user location.

In the above described embodiments each user 147, 150 is assigned a respective optical carrier frequency, but it will be appreciated that when implementing access using Time Division Multiplexing (TDM) each group of users would be assigned a respective optical carrier frequency. Whilst these embodiments may require two optical fibres between the WDM distribution node 144 and a respective ONT 148, or a radio interface 152, the advantages of a passive network and single optical fibre 146 between the CO node 142 and the WDM distribution node 144 are maintained.

1. A communications node for providing communications services to at least one user, the node being arranged to transmit an optical signal comprising at least one Wavelength Division Multiplexing channel in a downstream direction, wherein at least one of the channels is an unmodulated channel which is further arranged to transmit user data from the at least one user in the upstream direction.

2. A communications node according to claim 1, wherein the optical signal is comprised of at least one modulated Wavelength Division Multiplexing channel.

3. A communications node according to claim 2, wherein the optical signal is comprised of alternate wavelengths of modulated and unmodulated Wavelength Division Multiplexing channels.

4. A communications node according to claim 2, wherein the optical signal is comprised of groups of adjacent wavelengths of modulated or unmodulated Wavelength Division Multiplexing channels.

5. A communications node according to claim 1 and further arranged to transmit the optical signal in the downstream direction to a Wavelength Division Multiplexing splitter, the splitter arranged to demultiplex the channels and to separate the modulated channels from the unmodulated channels, the splitter further arranged to receive the user data for transmission in the upstream direction.

6. A communications node according to claim 5, wherein the splitter is arranged to associate a separated modulated channel with a separated unmodulated channel, and to transmit the associated modulated and unmodulated channels in the downstream direction.

7. A communications node according to claim 6, and further arranged to transmit the associated modulated and unmodulated channel to a user device, the user device being arranged to: transmit the modulated channel to the at least one user; receive the user data; and modulate the unmodulated channel using the user data for transmission of the user data in the upstream direction.

8. A communications node according to claim 2 including an optical periodic notch filter which is operable to separate the at least one unmodulated Wavelength Division Multiplexing channel from the modulated Wavelength Division Multiplexing channel.

9. A communications node according to claim 2 wherein outputs of the node are arranged as pairs of optical fibres, one fibre of each pair of optical fibres having a modulated Wavelength Division Multiplexing channel and the other optical fibre of each pair having an unmodulated Wavelength Division Multiplexing channel.

10. A communications node according to claim 1 arranged to receive the optical signal from the upstream direction over a single optical fibre.

11. A Communications node according to claim 1 arranged to transmit the optical signal in the upstream direction over a single optical fibre.

12. A Communications node according to claim 1 arranged to transmit the user data in a downstream direction on one optical fibre, and the at least one unmodulated channels on another optical fibre.

13. A Communications node according to claim 2 wherein the at least one modulated channel is comprised of at least one optical single side band modulated signal.

14. A communications node for providing communications services to at least one user, the node being arranged to receive an optical signal comprising at least one Wavelength Division Multiplexing channel from an upstream direction, each channel comprising a carrier frequency and optical data, the node arranged to separate the respective carrier frequency from the optical data, and to transmit the separated optical data and the carrier frequency in the downstream direction, wherein the at least one carrier frequency is arranged to transmit user data from the at least one user in the upstream direction.

15. A communications node according to claim 14, including an optical periodic notch filter which is operable to separate the at least one carrier frequency from optical data.

16. A Communications node according to claim 14 wherein outputs of the node are arranged as pairs of optical fibres, one fibre of each pair of optical fibres having a modulated Wavelength Division Multiplexing channel and the other optical fibre of each pair having an unmodulated Wavelength Division Multiplexing channel.

17. A communications node according to claim 14 wherein the user data is transmitted as an optical single side band modulated signal.

18. A communications node according to claim 14 arranged to receive the optical signal from the upstream direction over a single optical fibre.

19. A communications node according to claim 14 arranged to transmit an optical signal in the upstream direction over a single optical fibre.

20. A communications node for providing communications services to at least one user, the node being arranged to transmit an optical signal comprising at least one Wavelength Division Multiplexing channel in a downstream direction, wherein each channel comprises a carrier frequency and optical data for the at least one user, the node being further arranged to receive an upstream optical signal comprising the at least one carrier frequency and user data from the at least one user.

21. A communications node according to claim 20 and further including an optical single side band modulator for generating the downstream optical signal.

22. A Communications node according to claim 20 arranged to transmit the downstream optical signal over a single optical fibre.

23. A Wavelength Division Multiplexing splitter arranged to receive an optical signal comprising at least one Wavelength Division Multiplexing channel from an upstream direction, wherein at least one of the channels are modulated channels, and at least one of the channels is an unmodulated channel, the splitter arranged to demultiplex the channels and to separate the modulated channels from the unmodulated channels to provide communication services to at least one user in a downstream direction, and to receive user data for transmission in the upstream direction which has been used to modulate the at least one unmodulated channel.

24. A splitter according to claim 23, and further arranged to associate a separated modulated channel with a separated unmodulated channel, and to transmit the associated modulated and unmodulated channels in the downstream direction.

25. A user device arranged to receive an optical signal comprising an unmodulated Wavelength Division Multiplexing channel from an upstream direction, to receive user data from a downstream direction, and to modulate the unmodulated channel with the user data for transmission of the user data in the upstream direction.

26. A user device according to claim 25 arranged to receive an optical signal comprising at least one modulated Wavelength Division Multiplexing channel from an upstream direction, and to transmit the at least one modulated Wavelength Division Multiplexing channels to at least one user in the downstream direction.

27. A user device according to claim 25 arranged to receive the user data from an upstream direction on one optical fibre, and the unmodulated Wavelength Division Multiplexing channel on another optical fibre.

28. A method of operating a communications network for providing communications services to at least one user, the method including transmitting an optical signal comprising at least one Wavelength Division Multiplexing channel in a downstream direction, wherein at least one of the channels is an unmodulated channel, and using the at least one unmodulated channel to transmit user data from the at least one user in the upstream direction.

29. A method according to claim 28 and further including transmitting at least one modulated channel in the optical signal.

30. A method according to claim 29 and further including using an optical signal having alternate wavelengths of modulated and unmodulated Wavelength Division Multiplexing channels.

31. A method according to claim 29 and further including using an optical signal comprised of groups of adjacent wavelengths of modulated and unmodulated Wavelength Division Multiplexing channels.

32. A method according to claim 29 and further including demultiplexing the at least one Wavelength Division Multiplexing channel and separating the modulated channels from the unmodulated channels.

33. A method according to claim 32 and further including associating a separated modulated channel with a separated unmodulated channel, and transmitting the associated modulated and unmodulated channels in the downstream direction.

34. A method according to claim 33 and further including transmitting the associated modulated and unmodulated channel to a user device for transmitting the modulated channel to the at least one user, receiving the user data;
and modulating the unmodulated channel using the user data for transmission of the user data in the upstream direction.

35. A method according to claim 29 and further including distinguishing the modulated channel from the user data.

36. A method of operating a communications node for providing communications services to at least one user, the method including; transmitting a downstream optical signal from the node comprising at least one Wavelength Division Multiplexing channel, wherein each channel comprises a carrier frequency and optical data for the at least one user; and
receiving an upstream optical signal at the node comprising the at least one carrier frequency and user data from the at least one user.

37. A method of operating a communications node according to claim 36 and further including using an optical single side band modulated signal as the downstream optical signal.

38. A method of operating a communications node according to claim 33 and further including transmitting the downstream optical signal over a single optical fibre.

39. A method of operating a communications node for providing communications services to at least one user, the method including; receiving an optical signal at the node from an upstream direction, the optical signal comprising at least one Wavelength Division Multiplexing channel comprising a carrier frequency and optical data; separating the respective carrier frequency from the optical data; transmitting the carrier frequency from the node in the downstream direction; and transmitting user data from the at least one user in the upstream direction using the at least one carrier frequency.

40. A method according to claim 39 and further including transmitting the separated optical data from the node in the downstream direction.

41. A method according to claim 39 and further including arranging outputs of the node as pairs of optical fibres, one fibre of each pair of optical fibres having a modulated Wavelength Division Multiplexing channel and the other optical fibre of each pair having an unmodulated Wavelength Division Multiplexing channel.

42. A method according to claim 39 and further including transmitting the optical data using at least one optical single side band modulated signal.

43. A method according to claim 39 and further including receiving the optical signal from the upstream direction over a single optical fibre.

44. A method according to claim 39 and further including transmitting the optical signal in the upstream direction over a single optical fibre.

45. A method of operating a user device for providing communications services to at least one user, the method including; receiving an optical signal from an upstream direction comprising an unmodulated WDM channel; receiving user data at the user device from a downstream direction; modulating the unmodulated WDM channel with the user data; and transmitting the user data in the upstream direction.

46. A method according to claim 45 and further including receiving an optical signal at the user device from an upstream direction comprising at least one modulated Wavelength Division Multiplexing channel, and transmitting the at least one modulated channel to the at least one user.

47. A method according to claim 45 and further including receiving the unmodulated Wavelength Division Multiplexing channel at a reflective semiconductor optical amplifier, modulating the unmodulated channel with the user data, and transmitting the modulated channel in the upstream direction.

48. A method according to claim 47 and further including receiving the user data from an upstream direction on one optical fibre, and the unmodulated Wavelength Division Multiplexing channel on another optical fibre.

49. A communications network including a communications node according to claim 1.
